(19) United States
(12) Patent Application Publication
(10) Pub. No.: US 2008/0037250 A1
(43) Pub. Date: Feb. 14, 2008

(54) Lamp supporting device and backlight device

(75) Inventors: Masaki Shimizu, Kameyama-shi (JP); Tsutomu Tsuji, Tsu-shi (JP); Takaharu Kikuchi, Tsu-shi (JP)

Correspondence Address: BIRCH STEWART KOLASCH & BIRCH, PO BOX 747, FALLS CHURCH, VA, 22040-0747, US

(73) Assignee: SHARP KABUSHIKI KAISHA

(21) Appl. No.: 11/882,917

(22) Filed: Aug. 7, 2007

(30) Foreign Application Priority Data
Aug. 8, 2006 (JP) 2006-216167
Jul. 4, 2007 (JP) 2007-176385

(51) Int. Cl. F21V 21/00

(52) U.S. Cl. 362/249

(57) ABSTRACT

A lamp supporting device for supporting a plurality of lamps so as to be juxtaposed includes the first and second mounting holes for mounting the first lamp holding member having a plurality of holding parts for holding middle parts of the lamps and the second lamp holding member having a holding part of the number different from that of the holding parts of the first lamp holding member; and identifying means for identifying positions to which the first and second lamp holding members are mounted.

### CROSS-REFERENCE TO RELATED APPLICATIONS

This Nonprovisional application claims priority under 35 U.S.C.§119(a) on Patent Application No. 2006-216167 filed in Japan on Aug. 8, 2006 and Patent Application No. 2007-176385 filed in Japan on Jul. 4, 2007, the entire contents of which are hereby incorporated by reference.

### BACKGROUND

1. Technical Field

The present invention relates to a lamp supporting device for supporting a plurality of lamps so as to be juxtaposed and a backlight device provided with the lamp supporting device.

2. Description of Related Art

A display device such as a television has a backlight device disposed at a rear side of a display section having a display surface for displaying an image on the front side, and the backlight device is provided with a lamp supporting device for supporting a plurality of lamps so as to be juxtaposed.

The backlight device includes a housing member with front side opened; a plurality of lamps juxtaposed vertically in the housing member at a different interval; and an end holder for holding both ends of the lamps inside the housing member (for example, see Japanese Patent Application Laid-Open No. 6-75216 (1994)). The lamps are constituted so as to reduce the number of lamps by narrowing the interval between the lamps positioned at a central part in a vertical direction and enlarging the interval between the lamps positioned at an upper side and a lower side, thereby obtaining a highest luminance of the lamps positioned at the central part of the display surface, and gradually reducing the luminance of the lamps toward vertical ends of the display surface.

The display device such as the television, etc., tends to be upsized, and with an upsize of the display device, a dimension of a lamp of the backlight device is set longer. Therefore, a conventionally known backlight device is constituted in such a way that by using a lamp holding member for holding the length directional central parts of the lamps and mounting the lamp holding member to the housing member, the lamps are protected and an accuracy of juxtaposition of the lamps can be maintained (for example, see Japanese Patent Application Laid-Open No. 2001-210126). The lamp holding member includes the first lamp holding member having two of the first holding parts for holding middle parts of adjacent two lamps and the first mounting part mounted to the housing member; and the second lamp holding member having the second holding part for holding a middle part of one lamp and the second mounting part mounted to the housing member, and the first mounting hole corresponding to the first mounting part and the second mounting hole corresponding to the second mounting part are opened in the housing member.

Incidentally, when the central parts of the lamps is held by using the lamp holding members described in Japanese Patent Application Laid-Open No. 2001-210126 in the backlight device described in Japanese Patent Application Laid-Open No. 6-75216 (1994), the following three methods are taken into consideration.
(1) The second lamp holding members are alternately disposed in a staggered manner along the juxtaposed direction of the lamps.
(2) A plurality of kinds of the first lamp holding members with different distance between two of the first holding parts are alternately disposed in a staggered manner along the juxtaposed direction of the lamps.
(3) The first lamp holding member and the second lamp holding member are used in combination with each other.

### SUMMARY

However, in a case of the description (1), there is a problem that it is impossible to hold two or more of lamps at once, thus increasing the number of the second lamp holding members relative to the number of all lamps and assembling workability of the lamp holding members is thereby deteriorated.

In addition, in a case of the description (2), there is a problem that a forming mold is required for each of the plurality of kinds of the first lamp holding members corresponding to the interval between the juxtaposed lamps, thus increasing a manufacturing cost of the lamp holding members including depreciation of the forming mold, resulting in increasing the cost of the backlight device.

Further, in a case of the description (3), problems of the descriptions of (1) and (2) can be alleviated. However, when the first lamp holding members and the second lamp holding members are mounted to specified positions of the housing member, there is a possibility of erroneously mounting the first lamp holding members and the second lamp holding members.

In view of the above-described circumstances, a main object is to provide a lamp supporting device capable of recognizing a difference in mounting means for mounting the first and second lamp holding members, by having the mounting means for mounting the first and second lamp holding members for holding middle parts of a plurality of juxtaposed and supported lamps, and identifying means for identifying positions where the first and second lamp holding members are mounted.

In addition, another object is to provide the lamp supporting device capable of mounting the first and second lamp holding members without error, by defining the mounting means for mounting the first and second lamp holding members as the first and second mounting holes, and defining the identifying means as the first and second mounting holes.

Still another object is to provide the lamp supporting device capable of mounting the first and second lamp holding members without error, by forming the first and second mounting holes in different shapes from each other.

Still another object is to provide the lamp supporting device capable of mounting the first and second lamp holding members without error, by forming one of the first and second mounting holes in a circular shape and forming the other mounting hole in a square shape.

Still another object is to provide the lamp supporting device capable of improving mounting workability to the mounting holes of the first and second lamp holding members, by opening the first and second mounting holes of the same number separately from one another along a direction in which the lamps are juxtaposed.

Still another object is to provide the lamp supporting device capable of easily recognizing the difference in the first and second mounting holes in combination with the identifying means, by opening the first and second mounting holes at different positions in a length direction of the lamps.

Still another object is to provide the lamp supporting device capable of easily recognizing the difference in the first and second mounting holes at positions where the first and second mounting holes are adjacent to each other, by opening the first and second mounting holes of the different number, and opening one of the first and second mounting holes at a different position from the other mounting hole holding an adjacent lamp in the length direction of the lamps.

Still another object is to provide the lamp supporting device capable of mounting the first and the second lamp holding members without error, by forming the mounting holes, to which the first lamp holding member is mounted, in the same number as the number of the holding parts of the first lamp holding member or in the plural number not beyond the number of the holding parts of the first lamp holding member.

Still another object is to provide the lamp supporting device capable of improving the mounting workability to the mounting holes of the first and second lamp holding members, by opening a plurality of mounting holes to which the first lamp holding member is mounted, in a direction in which the lamps are juxtaposed.

Still another object is to provide the lamp supporting device capable of differentiating the first mounting hole and the second mounting hole, by recognizing the number of mounting holes for mounting the second lamp holding member, as one.

Still another object is to provide a backlight device capable of mounting the first and second holding members of the backlight device without error by using the lamp supporting device provided with the first and second mounting holes, the backlight device having a plurality of lamps juxtaposed at a gradually different interval in a direction in which the lamps are juxtaposed.

Still another object is to provide the backlight device capable of mounting the first and second lamp holding members of the backlight device without error by using the lamp supporting device provided with the first and second mounting holes, the backlight device being formed so that the interval between the lamps positioned in the vicinity of the central part out of the plurality of lamps is made narrower than the interval between the lamps positioned at an end or a peripheral part in a direction in which the lamps are juxtaposed.

Still another object is to provide the backlight device capable of mounting the first and second lamp holding members of the backlight device without error by using the lamp supporting device provided with the first and second mounting holes, the backlight device being formed so that the interval between the lamps positioned at both ends or both peripheral parts in the direction in which the lamps are juxtaposed out of the plurality of lamps is made larger than the interval between the lamps positioned in the vicinity of the central part.

Still another object is to provide the backlight device capable of differentiating the first lamp holding member and the second lamp holding member without changing the shapes of the first and second lamp holding members, by forming the first and second lamp holding members in the same color or the same material respectively.

A lamp supporting device according to the first aspect is characterized by a lamp supporting device for supporting a plurality of lamps so as to be juxtaposed, comprising: mounting means for mounting the first lamp holding member having a plurality of holding parts for holding middle parts of the lamps, and the second lamp holding member having a holding part of the number different from that of the holding parts of the first lamp holding member; and identifying means for identifying positions to which the first and second lamp holding members are mounted.

According to the first aspect, by visually confirming the identifying means, it is possible to recognize the difference in the mounting means for mounting the first and second lamp holding members. Therefore, the first and second lamp holding members can be mounted without error.

Further, a lamp supporting device according to the second aspect is characterized in that the mounting means is the first and second mounting holes opened in the surface opposed to the lamps, and the identifying means are the first and second mounting holes.

According to the second aspect, by visually confirming the first and second mounting holes opened in the surface opposed to the lamps, it is possible to recognize the difference in the mounting holes to which the first and second lamp holding members are mounted. Therefore, the first and second lamp holding members can be mounted without error.

Further, a lamp supporting device according to the third aspect is characterized in that the first and second mounting holes have different shapes.

According to the third aspect, by visually confirming the first mounting hole and the second mounting hole, it is possible to recognize that one of the hole shapes is the first mounting hole, and the other hole shape is the second mounting hole. Therefore, the first and second lamp holding members can be mounted without error.

Further, a lamp supporting device according to the fourth aspect is characterized in that one of the first and second mounting holes is in a circular shape, and the other mounting hole is in a square shape.

According to the fourth aspect, by visually confirming the first mounting hole and the second mounting hole, it is possible to recognize that one of the hole shapes is the first mounting hole and the other hole shape is the second mounting hole. Therefore, the first and second lamp holding members can be mounted without error.

Further, a lamp supporting device according to the fifth aspect is characterized in that said first and second mounting holes of the same number are opened separately from one another along a direction in which said lamps are juxtaposed.

According to the fifth aspect, mounting workability of the first and second lamp holding members to the mounting holes can be improved.

Further, a lamp supporting device according to the sixth aspect is characterized in that the first and second mounting holes are opened in different positions along the length direction of the lamps.

According to the sixth aspect, the positions of the first and second mounting holes are different in the length direction of the lamps. Therefore, it is possible to easily recognize the difference in the first and second mounting holes in combination with the identifying means, and the first and second lamp holding members can be mounted without error.

Further, a lamp supporting device according to the seventh aspect is characterized in that the first and second mounting holes of the different number are opened, and one of the first and second mounting holes is opened in the position different from the other mounting hole for holding the adjacent lamp in the length direction of the lamps.

According to the seventh aspect, the first mounting hole and the second mounting hole are opened separately from one another along the length direction of the lamps, at the positions where the first mounting hole and the second mounting hole are adjacent to each other. Therefore, the difference in the first and second mounting holes can be easily recognized at the positions where the first and second mounting holes are adjacent to each other, and the first and second lamp holding members can be mounted without error.

Further, a lamp supporting device according to the eighth aspect is characterized in that the number of the mounting holes for mounting said first lamp holding member are the same number as the number of the holding parts of the first lamp holding member or the plural number not beyond the number.

According to the eighth aspect, it is possible to recognize the mounting holes to which the first lamp holding member is mounted so as to correspond to the number of the holding parts. Therefore, the first and second lamp holding members can be mounted without error.

Further, a lamp supporting device according to the ninth aspect is characterized in that a plurality of mounting holes, to which the first lamp holding member is mounted, are opened in a direction in which the lamps are juxtaposed.

According to the ninth aspect, the mounting workability to the mounting holes of the first lamp holding member can be improved.

Further, a lamp supporting device according to the tenth aspect is characterized in that the number of the mounting hole, to which the second lamp holding member is mounted, is one.

According to the tenth aspect, by recognizing the number of the mounting holes, it is possible to differentiate the first mounting hole and the second mounting hole. Therefore, the mounting workability of the first and second lamp holding members to the mounting holes can be improved.

Further, a backlight device according to the eleventh aspect is characterized by a backlight device, comprising: a plurality of juxtaposed lamps; the first lamp holding member having a plurality of holding parts for holding middle parts of the lamps; the second lamp holding member having a holding part of the number different from that of the holding parts of the first lamp holding member; and the lamp supporting device, wherein said plurality of lamps are juxtaposed, with gradually different intervals along the direction in which the lamps are juxtaposed, by being held by said first and second lamp holding members.

According to the eleventh aspect, it is possible to recognize the difference in the first and second mounting holes. Therefore, the first and second lamp holding members can be mounted without error, and the mounting workability of the lamp holding members can be improved.

Further, a backlight device according to the twelfth aspect is characterized by a backlight device, comprising: a plurality of juxtaposed lamps; the first lamp holding member having a plurality of holding parts for holding middle parts of the lamps; the second lamp holding member having a holding part of the number different from that of the holding parts of the first lamp holding member; and the lamp supporting device, wherein an interval between lamps positioned in the vicinity of a central part out of said plurality of lamps is made narrower than the interval between lamps positioned in an end or peripheral part in a direction, in which the lamps are juxtaposed.

According to the twelfth aspect, it is possible to recognize the difference in the first and second mounting holes. Therefore, the first and second holding members can be mounted without error, and the mounting workability of the lamp holding members can be improved.

Further, a backlight device according to the thirteenth aspect is characterized in that a backlight device, comprising: a plurality of juxtaposed lamps; the first lamp holding member having a plurality of holding parts for holding middle parts of the lamps; the second lamp holding member having a holding part of the number different from that of the holding parts of the first lamp holding member; and the lamp supporting device, wherein an interval between lamps positioned at both ends or both peripheral parts in a direction, in which the lamps are juxtaposed, out of said plurality of lamps is made larger than the interval between lamps positioned in the vicinity of the central part.

According to the thirteenth aspect, it is possible to recognize the difference in the first and second mounting holes. Therefore, the first and second lamp holding members can be mounted without error, and the mounting workability of the lamp holding members can be improved.

Further, a backlight device according to the fourteenth aspect is characterized in that the first and second lamp holding members are formed in the same color or same material respectively.

According to the fourteenth aspect, it is possible to differentiate the first lamp holding member and the second lamp holding member, without changing the shapes of the first and second lamp holding members, and the first and second lamp holding members can be mounted without error.

The above and further objects and features will more fully be apparent from the following detailed description with accompanying drawings.

### BRIEF DESCRIPTION OF THE SEVERAL VIEWS OF THE DRAWINGS

FIG. 1 is a front view showing a structure of a backlight device provided with a lamp supporting device;

FIG. 2 is a front view of an expanded essential part of the backlight device;

FIG. 3 is a schematic view showing a relation between a lamp holding member and a mounting hole of the backlight device;

FIG. 4 is an expanded sectional view of a mounting part of the first lamp holding member;

FIG. 5 is an expanded sectional view of a mounting part of the second lamp holding member;

FIG. 6A is a side view showing structure of the first lamp holding member;

FIG. 6B is a front view structure of the first lamp holding member;

FIG. 7A is a side view showing the structure of the second lamp holding member;

FIG. 7B is a front view showing the structure of the second lamp holding member;

FIG. 8 is a schematic view of an arrangement example of the first lamp holding member and the second lamp holding member of the backlight device with relatively large numbers of juxtaposed lamps;

FIG. 9 is a front view showing other structure of the backlight device provided with the lamp supporting device;

FIG. 10 is a front view of an expanded essential part of the backlight device;

FIG. 11 is a schematic view showing a relation between the lamp holding member and the mounting hole of the backlight device;

FIG. 12 is a schematic view showing the arrangement example of the first lamp holding member and the second lamp holding member of the backlight device with relatively large numbers of juxtaposed lamps; and

FIG. 13 is a schematic view showing the arrangement example of the first lamp holding member and the second lamp holding member of the backlight device in which odd-numbered lamps are juxtaposed.

### DETAILED DESCRIPTION

Preferred embodiments will be described in detail hereunder, based on the drawings.

### Embodiment 1

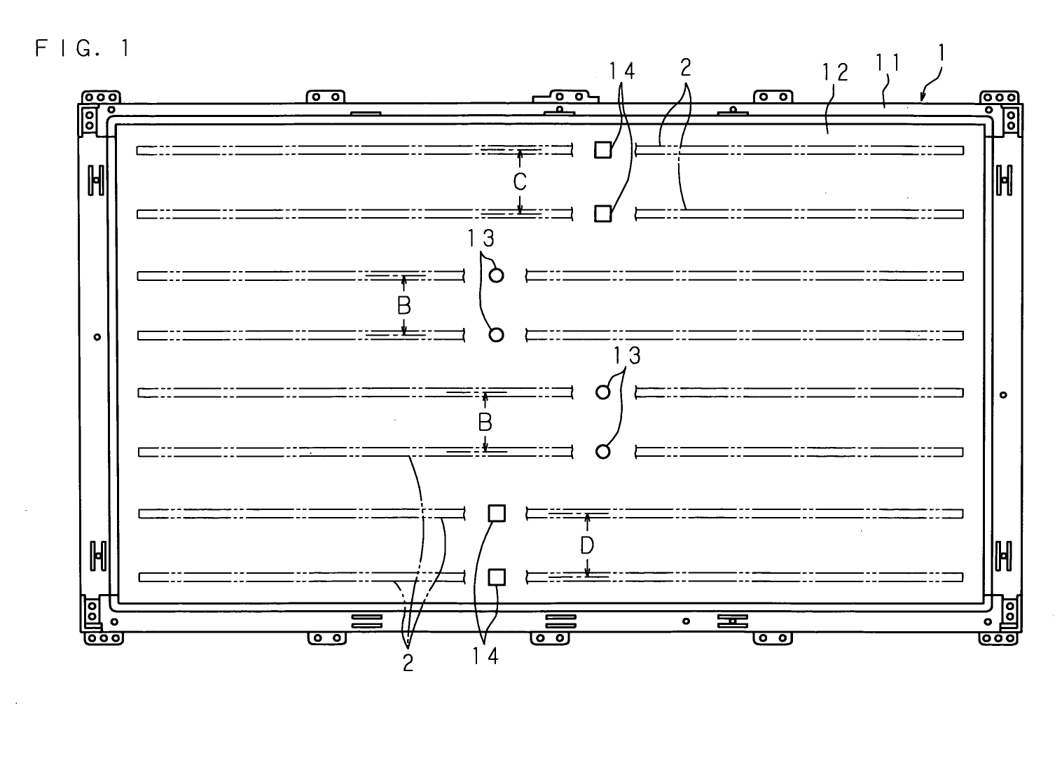

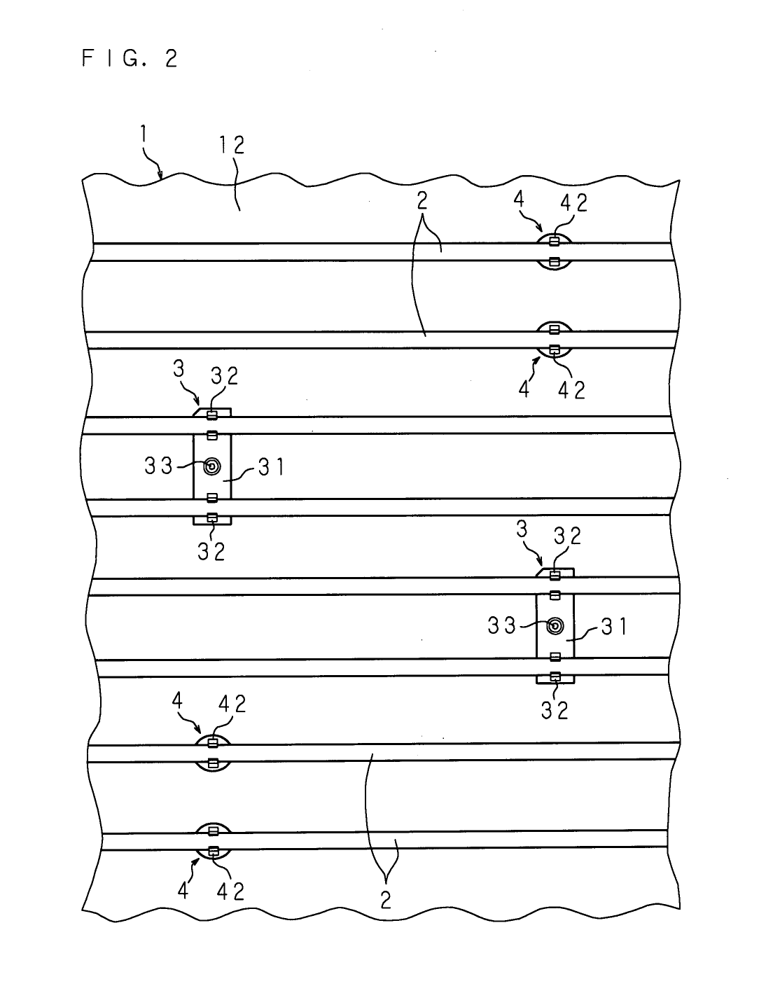

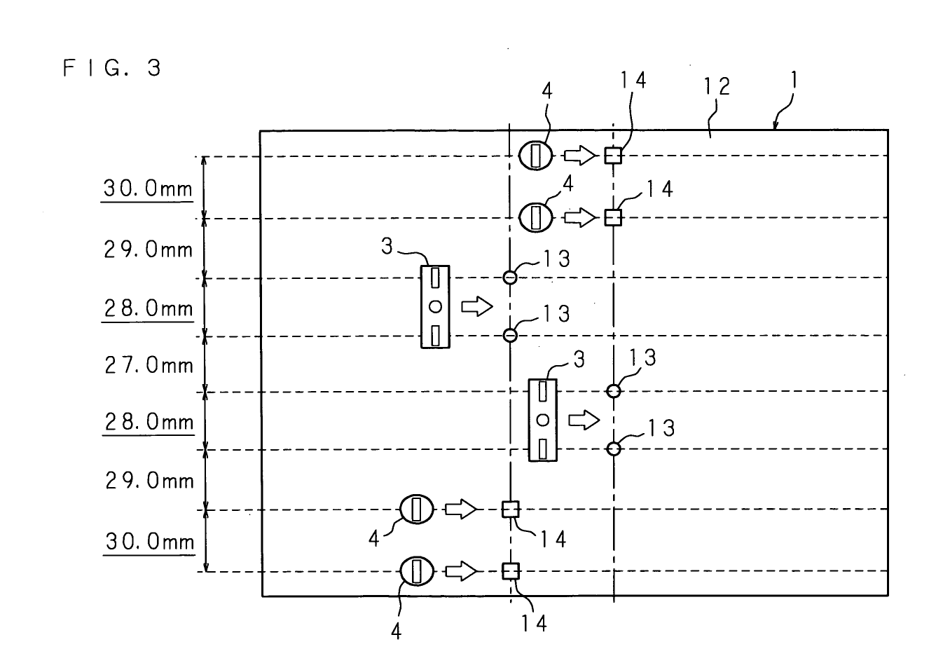

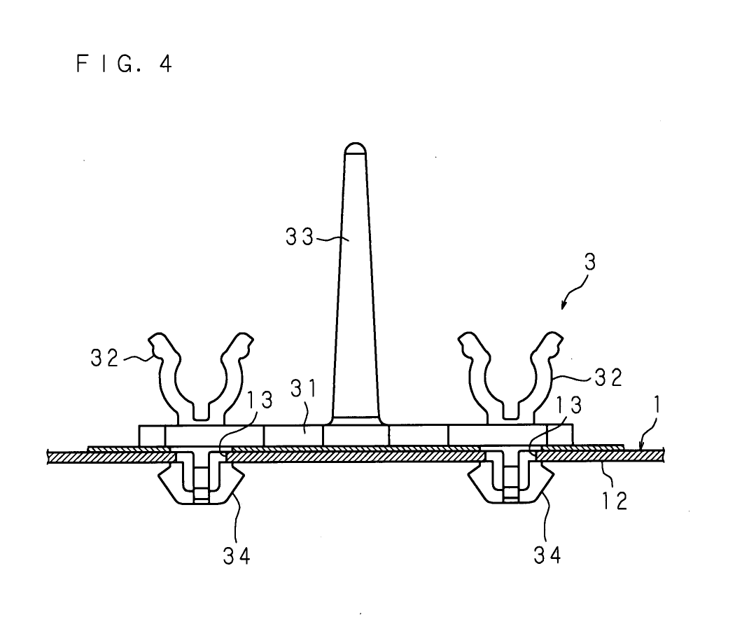

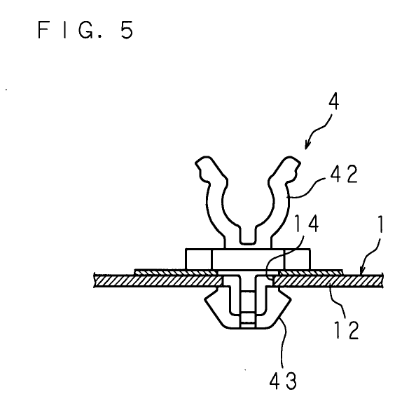

FIG. 1 is a front view showing a structure of a backlight device provided with a lamp supporting device, FIG. 2 is a front view of an expanded essential part, FIG. 3 is a schematic view showing a relation between a lamp holding member and a mounting hole, FIG. 4 is an expanded sectional view of a mounting part of the first lamp holding member, and FIG. 5 is an expanded sectional view of a mounting part of the second lamp holding member.

The backlight device of Embodiment 1 comprises a housing member 1 in a box shape, with front side opened, having a frame part 11 in a rectangular solid shape and a rear wall 12, with a peripheral part connected to the frame part 11 to close a rear side end of the frame part 11; a plurality of lamps 2 in a cylindrical shape juxtaposed at a vertically different interval in the housing member 1; an end part holder for holding both end parts of the lamps 2 in the inside of the frame part 11; a plurality of the first lamp holding members 3 for holding on the rear wall 12 length directional central parts of the lamps 2 positioned in the vicinity of the central part in a juxtaposed direction; and a plurality of the second lamp holding members 4 for holding on the rear wall 12 the length directional central parts of the lamps 2 positioned in a vertical end in the juxtaposed direction or a vertical peripheral part, wherein the inner surface part of the housing member 1 serves as a reflective surface whereby the light emitted by the lamps 2 is reflected toward an opened part of the housing member 1.

The lamps 2 are juxtaposed so that the interval between the lamps positioned in the vicinity of the central part in the juxtaposed direction is smallest, and the interval between the lamps becomes gradually larger toward the upper and lower ends, and such a juxtaposed interval is maintained by the end part holder. For example, in FIGS. 1 to 3, the lamps are juxtaposed, at an interval A at the central part in the juxtaposed direction set at 27.0 mm, and at an interval B set at 28.0 mm, an interval C set at 29.0 mm, and an interval D set at 30.0 mm, toward the upper side and the lower side. In addition, the lamps 2 are cool cathode tubes having electrodes at both ends, and an inverter circuit board is connected to the electrode of each lamp 2, so that brightness is controlled by a pulse width modulation signal.

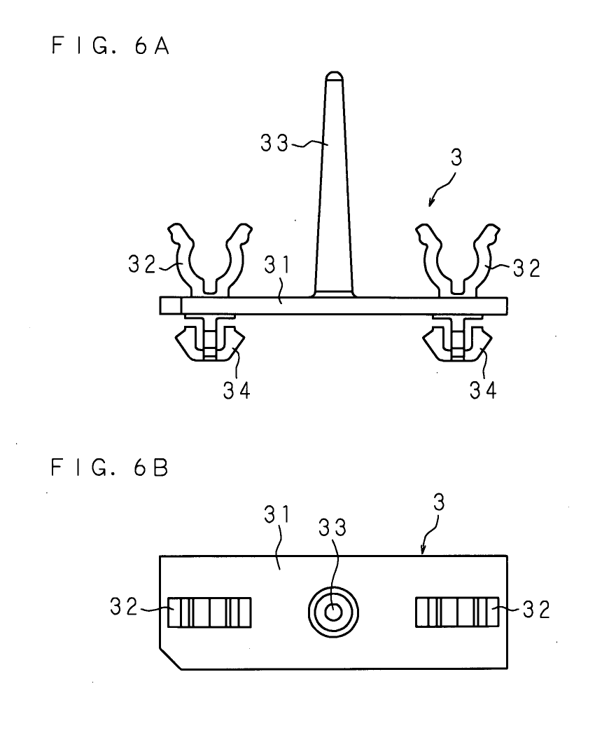

FIGS. 6A and 6B are a side view and a front view showing the structure of the first lamp holding member 3. The first lamp holding member 3 is made of synthetic resin and has a substrate 31 opposed to the reflective surface of the housing member 1; two of the first holding parts 32, 32 projected from one surface at an interval equal to the juxtaposed interval at the central side in the direction in which the lamps 2 are juxtaposed, into which the length directional central parts of two adjacent lamps 2, 2 are engaged and held; a columnar projection 33 projected from the central part between the first holding parts 32 and 32; and two of the first mounting parts 34 and 34 projected from the other surface of the substrate 31 at an interval equal to the juxtaposed interval, and the first lamp holding member 3 is integrally formed therewith.

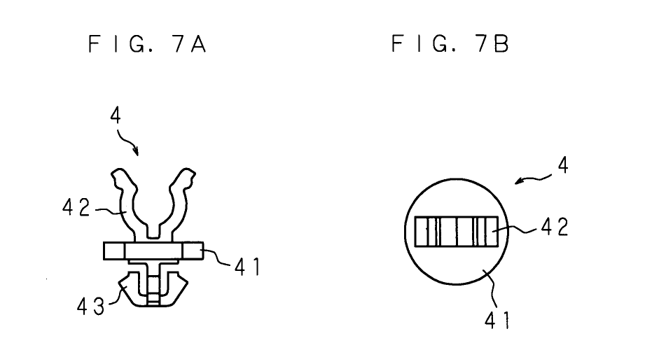

FIGS. 7A and 7B are a side view and a front view showing the structure of the second lamp holding member 4. The second lamp holding member 4 is made of synthetic resin and has a substrate 41 opposed to the reflective surface of the housing member 1; the second holding part 42 into which the length directional central parts of the lamps 2 at the upper side and lower side in the juxtaposed direction of the lamps 2 are engaged and held; and the second mounting part 43 projected from the other surface of the substrate 41, and the second lamp holding member 4 is integrally formed therewith.

The first holding part 32 and the second holding part 42 have two holding tongues for holding the lamp 2 respectively. The first mounting part 34 and the second mounting part 43 have two claw parts on the tip side of a plate-shaped projection tongue respectively, and the claw parts are locked to hole edge parts of the first mounting hole 13 and the second mounting hole 14 as will be described later. The columnar projection 33 is in a conical shape, and is extended from the substrate 31 in the direction opposite to the first mounting parts 34, 34.

As shown in FIG. 1, in the rear wall 12 of the housing member 1 constituting the lamp supporting device, the first mounting holes 13 are opened two by two in the juxtaposed direction of the lamps 2 for mounting two of the first lamp holding members 3 and 3, at an interval equal to the intervals B, B of the lamps 2 positioned in the vicinity of the central part in the juxtaposed direction, and at a position opposed to the lamps 2. In addition, the second mounting holes 14 are opened two by two in the juxtaposed direction of the lamps 2 for mounting the second lamp holding members 4, at an interval equal to the intervals C and D of the lamps 2 positioned in the peripheral part of the vertical end in the juxtaposed direction, and at positions opposed to the lamps 2. The first and second mounting holes 13 and 14 constitute the mounting means (mounting unit) for mounting the first and second lamp holding members 3 and 4, and the identifying means for identifying the positions to which the first and second lamp holding members 3 and 4 are mounted.

The first mounting holes 13 is in a circular shape and are opened two by two (four in total) in the juxtaposed direction of the lamps 2, and the second mounting holes 14 is in a square shape and are opened two by two (four in total at vertical positions) in the juxtaposed direction of the lamps 2. Further, two of the adjacent first mounting holes 13 and 13 and two of the adjacent second mounting holes 14 and 14 are alternately disposed in a staggered manner along the length direction of the lamps, the first mounting holes 13 and the second mounting holes 14 are disposed separately from one another along the length direction of the lamps 2, and a distance between the first lamp holding members 3, and a distance between the first lamp holding member 3 and the second lamp holding member 4 are made relatively longer.

In the backlight device thus constituted, the housing member 1 constitutes the lamp supporting device for supporting the juxtaposed lamps 2. As shown in FIG. 3, in the backlight device, the first mounting parts 34, 34 of the first lamp holding member 3 are inserted and locked to the first mounting holes 13, 13 of the housing member 1, and the second mounting part 43 of the second lamp holding member 4 is inserted and locked to the second mounting hole 14. In addition, a plurality of lamps 2 are juxtaposed with a distance therebetween vertically in the housing member 1, and by mounting the end part holder to the frame part 11, the both end parts of the lamps 2 are held in the housing member 1, and as shown in FIG. 2, the middle parts of the lamps 2 are inserted and held by the first holding parts 32, 32 of the first lamp holding members 3 and the second holding parts 42 of the second lamp holding members 4.

The first mounting holes 13 and the second mounting holes 14 opened in the rear wall 12 (or bottom wall) of the housing member 1 have different shapes, and the first mounting holes 13 are in a circular shape, and the second mounting holes 14 are in a rectangular shape. Therefore, the first lamp holding members 3 can be inserted and locked to the first mounting holes 13, and the second lamp holding members 4 can be inserted and locked to the second mounting holes 14, without error, thus improving the assembling workability of the lamp holding members. In addition, two of the adjacent first mounting holes 13 and two of the adjacent second mounting holes 14 are disposed separately from one another along the length direction of the lamps 2 and alternately in a staggered manner. Therefore, the first lamp holding members 3 mounted to the first mounting holes 13, and the second lamp holding member 4 mounted to the second mounting hole 14 and the first lamp holding member 3 are respectively disposed separately from one another, and an uneven luminance due to the first lamp holding members 3 and the second lamp holding members 4 can be reduced. Further, the second lamp holding members 4 not having the columnar projections 33 are disposed in a vertical peripheral part in the juxtaposed direction of the lamps 2, and the first lamp holding members 3 having the columnar projections 33 are disposed in the vicinity of the central part in the juxtaposed direction of the lamps 2. Therefore, by the columnar projections 33 of the first lamp holding members 3, it is possible to excellently prevent bending of the central part of the optical sheet which is easily bent, in the display device using the backlight device.

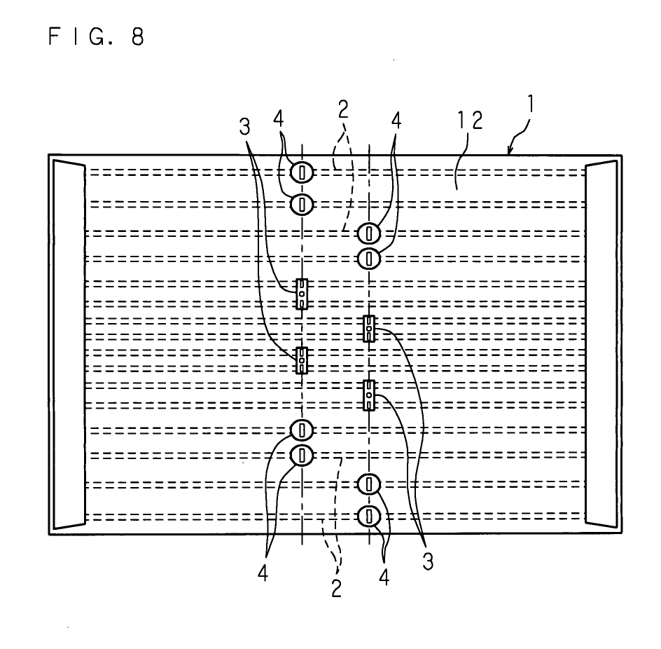

FIG. 8 is a schematic view showing an arrangement example of the first lamp holding members and the second lamp holding members of the backlight device having relatively large numbers of juxtaposed lamps. In this backlight device also, the first lamp holding members 3 are disposed in the vicinity of the central part in the juxtaposed direction, and the second lamp holding members 4 are disposed in the vertical peripheral part in the juxtaposed direction. In addition, the second lamp holding members 4 are alternately disposed in a staggered manner along the length direction of the lamps 2 together with the first lamp holding members 3, with two adjacent lamps as one set.

### Embodiment 2

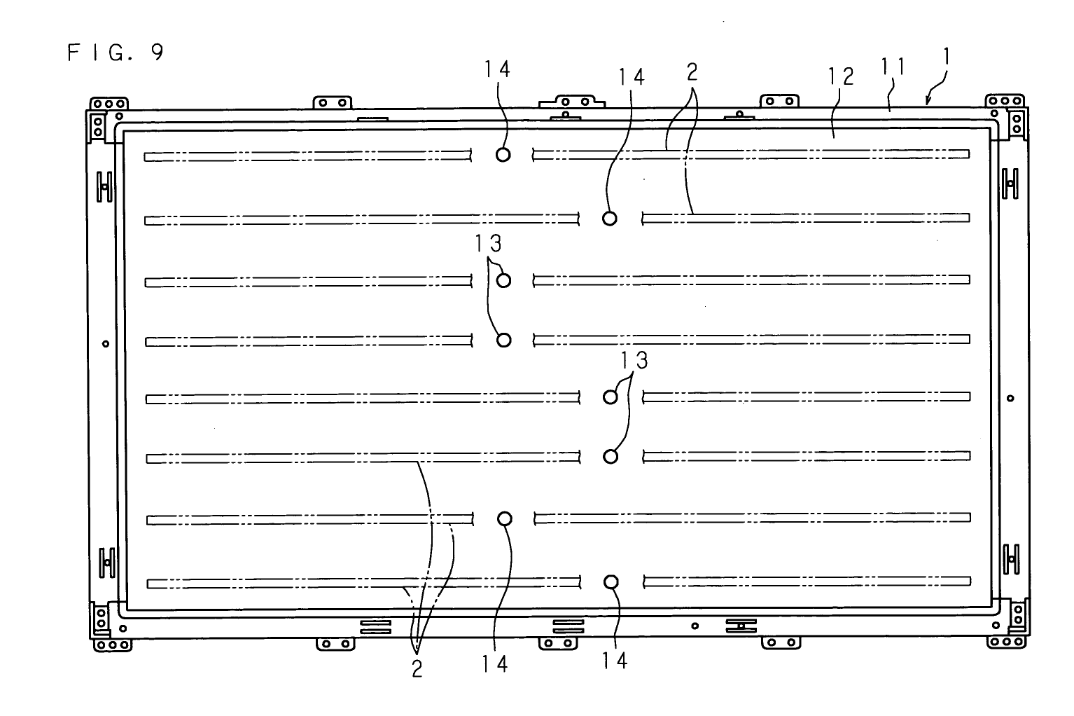

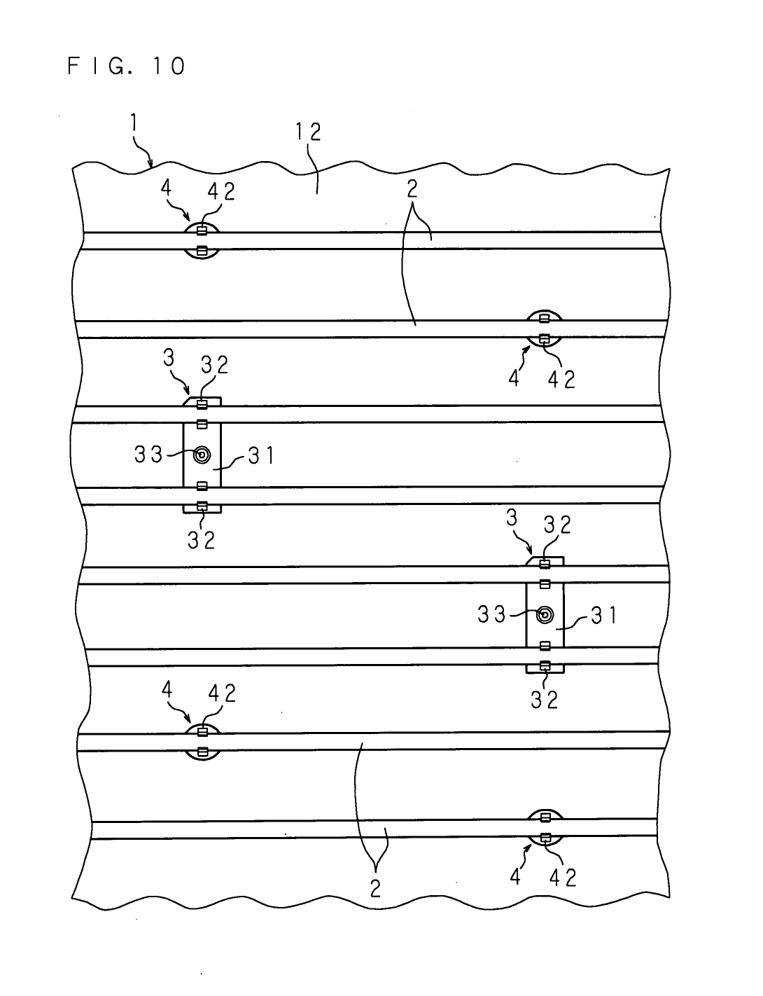

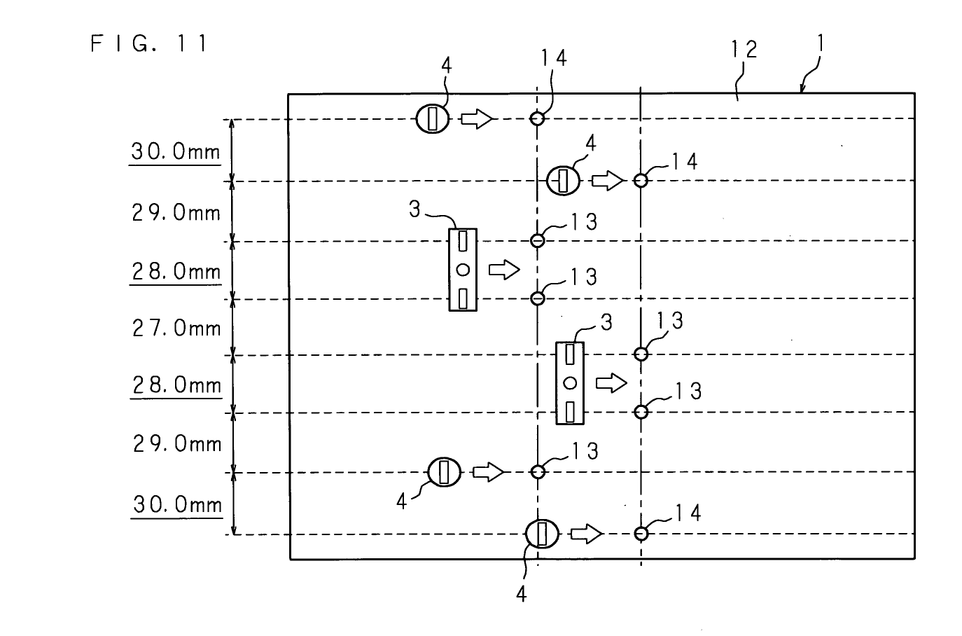

FIG. 9 is a front view showing other structure of the backlight device provided with the lamp supporting device, FIG. 10 is a front view of an expanded essential part, and FIG. 11 is a schematic view showing a relation between the lamp holding members and the mounting holes. In this backlight device, instead of differentiating the shapes of the first mounting holes 13 and the second mounting holes 14 as the identifying means for identifying the positions to which the first and second lamp holding members 3 and 4 are mounted, the first mounting holes 13 are opened two by two in the juxtaposed direction of the lamps 2, and the second mounting holes 14 vertically adjacent to the first mounting holes 13 are opened at the positions separate from the first mounting holes 13 along the length direction of the lamps 2, and further the second mounting holes 14 are opened, which are adjacent to each other in the juxtaposed direction, at the separate positions along the length direction of the lamps 2.

According to this backlight device, by visually confirming the first mounting holes 13 opened in the juxtaposed direction of the lamps 2, they can be recognized as the first mounting holes 13 for the first lamp holding members 3. In addition, by visually confirming the second mounting holes 14 disposed separate from the first mounting holes 13 along the length direction of the lamps 2, each of the second mounting holes 14 being disposed separately from one another along the length direction of the lamps 2, they can be recognized as the second mounting holes 14 for the second lamp holding members 4. Therefore, the first lamp holding members 3 can be inserted and locked to the first mounting holes 13, and the second lamp holding members 4 can be inserted and locked to the second mounting holes 14, without error, thus improving the mounting workability of the lamp holding members. In addition, two of the adjacent first mounting holes 13, 13 and two of the adjacent second mounting holes 14, 14 are alternately disposed in a staggered manner. Therefore, the first lamp holding members 3 mounted to the first mounting holes 13, and the second lamp holding member 4 mounted to the second mounting hole 14 and the first holding member 3 are respectively disposed separately from one another, thus making it possible to reduce the uneven luminance due to the first lamp holding members 3 and the second lamp holding members 4.

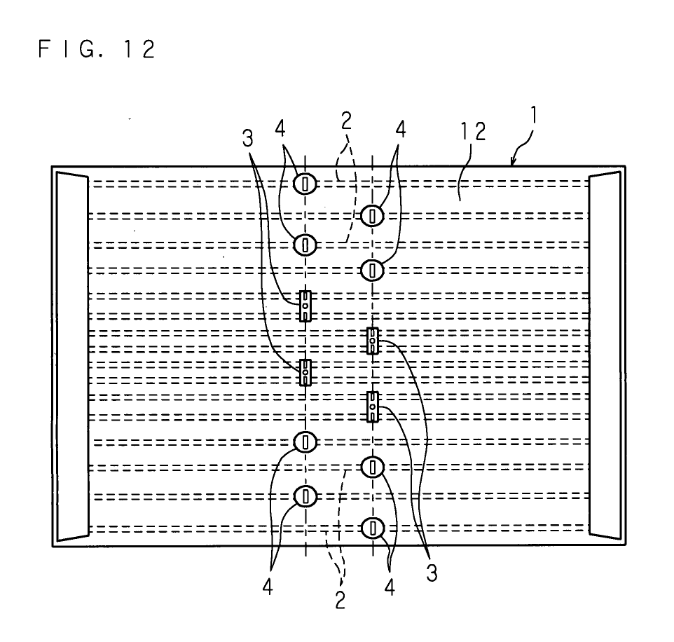

FIG. 12 is a schematic view showing the arrangement example of the first lamp holding members and the second lamp holding members of the backlight device having relatively large numbers of juxtaposed lamps. In this backlight device also, the first lamp holding members 3 are disposed in the vicinity of the central part in the juxtaposed direction, the second lamp holding members 4 are disposed in the vertical peripheral part in the juxtaposed direction, and the first lamp holding members 3 and the second lamp holding members 4 are alternately disposed in a staggered manner along the length direction of the lamps 2.

The other structure and action are the same as the backlight device of FIGS. 1 to 7B, and therefore the same signs and numerals are assigned to the same components, and detailed explanation and an explanation of the operation and effect are omitted.

Note that the backlight device may have the lamps 2 with all intervals between juxtaposed lamps made different, from the central part in the juxtaposed direction to the both ends in the juxtaposed direction, and may have the lamps 2 with stepwise different intervals between the juxtaposed lamps. In addition, the interval between the lamps positioned in the vicinity of the central part in the juxtaposed direction may be made narrower than the interval between the lamps positioned at the end or peripheral part in the juxtaposed direction, and the interval between the lamps positioned at both ends or both peripheral parts in the juxtaposed direction may be made larger than the interval between the lamps positioned in the vicinity of the central part in the juxtaposed direction.

In addition, by differentiating the number of the holding parts, the first and second lamp holding members are differentiated. However, in addition to this structure, the first and second lamp holding members may be formed with the same colors or materials respectively, and they may be differentiated by the difference of colors or materials.

In addition, in the embodiment as described above, the first lamp holding member 3 has two holding parts 32, 32, the second lamp holding member 4 has one holding part 42, and the difference in the holding parts of the first and second lamp holding members 3 and 4 is one. However, the difference in the holding parts of the first and second lamp holding members 3 and 4 may be two or more. However, when approximately five or more of the holding parts 32 of the lamp holding members 3 or the holding parts 42 of the lamp holding members 4 are disposed in the juxtaposed direction of the lamps, local deterioration of luminance corresponding to a location of the holding parts is easily visually recognized on a diffusion plate disposed outside the lamps. Therefore, preferably the number of the holding parts 32 and 42 of the lamp holding members 3 and 4 is four or less, respectively. Accordingly, when the lamp holding members 3 and 4 having four or less of the holding parts are disposed at different positions in the length direction of the lamps 2 (such as in a staggered manner), a special advantage can be achieved, such that it is possible to perform a mounting work while easily recognizing by a producer, or the like, the lamp holding members 3 and 4 to be mounted to the first mounting holes 13 or the second mounting holes 14 provided in the juxtaposed direction of the lamps of the housing member 1.

In addition, according to the above-described structure, the total number of the first and/or the second lamp holding members 3, 4, with the number of the holding parts being the odd number, is the odd number. Therefore, irrespective of the number of the holding parts of the lamp holding members, the odd-numbered lamps 2 can be held by a minimum-numbered lamp holding members. For example, when seven lamps 2 are juxtaposed, the lamps 2 can be held by one of the first lamp holding member 3 having four holding parts 32 and one of the second lamp holding members 4 having three holding parts 42, and the lamps 2 can be held by two of the first lamp holding members 3 having three holding parts 32 and one of the second lamp holding member 4 having one holding part 42.

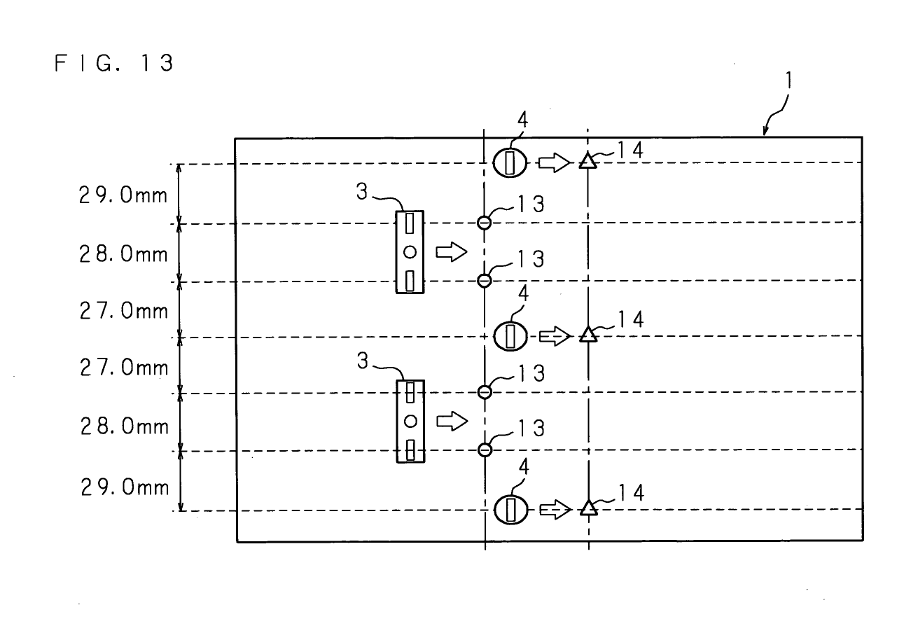

FIG. 13 is a schematic view showing the arrangement example of the first lamp holding members and the second lamp holding members of the backlight device in which the odd-numbered lamps are juxtaposed. This backlight device is provided with seven lamps 2 having different intervals from the central part in the juxtaposed direction to the both ends in the juxtaposed direction, wherein the shapes of the first mounting holes 13 and the second mounting holes 14 are differentiated as the identifying means for identifying the positions to which the first and second lamp holding members 3 and 4 are mounted, and further the first mounting holes 13 are opened two by two in the juxtaposed direction of the lamps 2, and the second mounting holes 14 vertically adjacent to the first mounting holes 13 are opened at the positions separate from the first mounting holes 13 along the length direction of the lamps 2.

Seven lamps 2 are juxtaposed toward the upper side and the lower side with respect to the central part in the juxtaposed direction, with intervals set at 27.0 mm, 28.0 mm, and 29.0 mm. The second mounting hole 14 is opened in the center in the juxtaposed direction, and the first mounting holes 13, 13 are opened in the juxtaposed direction of the lamps 2, at two positions on the upper side and the lower side with respect to the center in the juxtaposed direction respectively, and the second mounting holes 14, 14 are opened on the outermost side in the juxtaposed direction.

In this backlight device, the second mounting holes 14 are opened in the center in the juxtaposed direction of the lamps 2 and at both sides in the juxtaposed direction, and two of the first mounting holes 13, 13 are opened between the second mounting holes 14 and 14 respectively, at both sides of the center in the juxtaposed direction. Therefore, the first and second lamp holding members 3 and 4 can be orderly mounted, and the positions of the first and second mounting holes 13 and 14 can be easily visually recognized, thus improving the mounting workability of the first and second lamp holding members 3, 4 to the mounting holes.

As described above, by visually confirming the identifying means, it is possible to recognize the difference in the mounting means to which the first and second lamp holding members are mounted, and the first and second lamp holding members can be mounted without error.

Further, by visually confirming the first and second mounting holes opened in the surface opposed to the lamps, it is possible to recognize the difference in the mounting holes to which the first and second lamp holding members are mounted, and the first and second lamp holding members can be mounted without error.

Further, by visually confirming the first mounting hole and the second mounting hole, it is possible to recognize the difference in the shapes of the mounting holes, and the first and second lamp holding members can be mounted without error.

Further, by visually confirming the first mounting hole and the second mounting hole, it is possible to recognize the first mounting hole and the second mounting hole, and the first and second lamp holding members can be mounted without error.

Further, the first and second mounting holes of the same number are opened, separately from one another along the direction in which the lamps are juxtaposed. Therefore, the mounting workability of the first and second lamp holding members to the mounting holes can be improved.

Further, the positions of the first and second mounting holes are different in the length direction of the lamps. Therefore, it is possible to easily recognize the difference in the first and second mounting holes in combination with the identifying means, and the first and second lamp holding members can be mounted without error.

Further, the first and second mounting holes are disposed separately from one another at the positions where the first mounting hole and the second mounting hole are adjacent to each other, along the length direction of the lamps. Therefore, it is possible to easily recognize the difference in the first and second mounting holes at positions where the first and second mounting holes are adjacent to each other, and the first and second lamp holding members can be mounted without error.

Further, it is possible to recognize the mounting holes to which the first lamp holding member is mounted correspondingly to the number of the holding parts, and the first and second lamp holding members can be mounted without error.

Further, a plurality of mounting holes, to which the first lamp holding member is mounted, are opened in the direction in which the lamps are juxtaposed. Therefore, the mounting workability of the first lamp holding member to the mounting holes can be improved.

Further, it is possible to differentiate the first mounting hole and the second mounting hole by recognizing the number of the mounting holes, and the mounting workability of the first and second lamp holding members to the mounting holes can be improved.

Further, it is possible to recognize the difference in the first and second mounting holes, the first and second lamp holding members can be mounted without error, and the mounting workability of the lamp holding member can be improved.

Further, the first and second lamp holding members can be differentiated without changing the shapes of the first and second lamp holding members, and the first and second lamp holding members can be mounted without error.

As this description may be embodied in several forms without departing from the spirit of essential characteristics thereof, the present embodiment is therefore illustrative and not restrictive, since the scope is defined by the appended claims rather than by the description preceding them, and all changes that fall within metes and bounds of the claims, or equivalence of such metes and bounds thereof are therefore intended to be embraced by the claims.

What is claimed is:

1. A lamp supporting device for supporting a plurality of lamps so as to be juxtaposed, comprising:
a mounting unit for mounting the first lamp holding member having a plurality of holding parts for holding middle parts of the lamps, and the second lamp holding member having a holding part of the number different from that of the holding parts of the first lamp holding member, and for identifying positions to which the first and second lamp holding members are mounted.

2. The lamp supporting device according to claim 1, wherein said mounting unit is the first and second mounting holes opened in a surface opposed to said lamps.

3. The lamp supporting device according to claim 2, wherein said first and second mounting holes have different shapes.

4. The lamp supporting device according to claim 3, wherein one of said first and second mounting holes is in a circular shape, and the other one is in a square shape.

5. The lamp supporting device according to claim 3, wherein said first and second mounting holes of the same number are opened separately from one another along a direction in which said lamps are juxtaposed.

6. The lamp supporting device according to claim 3, wherein said first and second mounting holes are opened at different positions along the length direction of the lamps.

7. The lamp supporting device according to claim 2, wherein said first and second mounting holes of the different number are opened, and one of the first and second mounting holes is opened at a different position from the other mounting hole for holding an adjacent lamp, along the length direction of the lamps.

8. The lamp supporting device according to claim 7, wherein the number of the mounting holes for mounting said first lamp holding member are the same number as the number of the holding parts of the first lamp holding member or the plural number not beyond the number.

9. The lamp supporting device according to claim 8, wherein a plurality of mounting holes for mounting said first lamp holding member are opened in a direction in which the lamps are juxtaposed.

10. The lamp supporting device according to claim 7, wherein the number of the mounting hole for mounting said second lamp holding member is one.

11. A backlight device, comprising:
a plurality of juxtaposed lamps;
the first lamp holding member having a plurality of holding parts for holding middle parts of the lamps;
the second lamp holding member having a holding part of the number different from that of the holding parts of the first lamp holding member; and
the lamp supporting device according to claim 2,
wherein said plurality of lamps are juxtaposed, with gradually different intervals along the direction in which the lamps are juxtaposed, by being held by said first and second lamp holding members.

12. The backlight device according to claim 11, wherein said first and second lamp holding members are formed in the same color or same material respectively.

13. A backlight device, comprising:
a plurality of juxtaposed lamps;
the first lamp holding member having a plurality of holding parts for holding middle parts of the lamps;
the second lamp holding member having a holding part of the number different from that of the holding parts of the first lamp holding member; and
the lamp supporting device according to claim 2,
wherein an interval between lamps positioned in the vicinity of a central part out of said plurality of lamps is made narrower than the interval between lamps positioned in an end or peripheral part in a direction, in which the lamps are juxtaposed.

14. The backlight device according to claim 13, wherein said first and second lamp holding members are formed in the same color or same material respectively.

15. A backlight device, comprising:
a plurality of juxtaposed lamps;
the first lamp holding member having a plurality of holding parts for holding middle parts of the lamps;
the second lamp holding member having a holding part of the number different from that of the holding parts of the first lamp holding member; and
the lamp supporting device according to claim 2,
wherein an interval between lamps positioned at both ends or both peripheral parts in a direction, in which the lamps are juxtaposed, out of said plurality of lamps is made larger than the interval between lamps positioned in the vicinity of the central part.

16. The backlight device according to claim 15, wherein said first and second lamp holding members are formed in the same color or same material respectively.
